(19) United States
(12) Patent Application Publication
(10) Pub. No.: US 2024/0284563 A1
(43) Pub. Date: Aug. 22, 2024

(54) HEATING PRODUCT

(71) Applicant: MAS INNOVATION (PRIVATE) LIMITED, Battaramulla (LK)

(72) Inventors: Tharaka De Silva H.L., Battaramulla (LK); M. Chammika Perera, Battaramulla (LK); Maduka Chandrasiri, Battaramulla (LK)

(73) Assignee: MAS INNOVATION (PRIVATE) LIMITED, Battaramulla (LK)

(21) Appl. No.: 18/571,063

(22) PCT Filed: Jun. 10, 2022
(86) PCT No.: PCT/SG2022/050400

§ 371 Date: Dec. 15, 2023

(30) Foreign Application Priority Data
Jun. 15, 2021 (GB) 2108525.3

(51) Int. Cl. H05B 3/34; H05B 3/14; H05B 3/16; H05B 3/18

(52) U.S. Cl. CPC H05B 3/342; H05B 3/145; H05B 3/16; H05B 3/18; H05B 2203/003; H05B 2203/015; H05B 2203/017; H05B 2203/036

(57) ABSTRACT

Disclosed herein is a heating product that includes a base layer; a heating layer formed on the base layer, the heating layer formed from: a plurality of electrically conductive wires arranged electrically in parallel to each other; and thermally conductive cording yarns that attach each wire to the first fabric layer by cording embroidery, the cording yarns extending along and cording around the respective wire; and at least one thermally conductive layer formed on the base layer, wherein the wires are connectable to a power source for conducting an electrical current through the wires, thereby generating heat in the wires; and wherein the at least one thermally conductive layer is arranged for substantially uniform heat transfer from the heating layer.

### TECHNICAL FIELD

The present disclosure generally relates to a heating product. More particularly, the present disclosure describes various embodiments of the heating product for use in, such as a garment, for generating heat, and a method of making the heating product.

### BACKGROUND

Many garments in the market today incorporate heating elements to provide thermal comfort/therapeutic benefit to a user wearing the garment. Particularly, the garment is made through integration of the heating elements on the garment's fabric material. For example, the heating elements are continuous conductive yarns that are spread across the area of the fabric material where heating is desired. However, if the heating area is relatively large, the overall length of the conductive yarns is increased, and this causes higher overall electrical resistance in such a system. A power source would be needed to supply more electrical current to generate heat in the conductive yarns, and this often means the user would need to carry around a larger/heavier power source so that the garment can be used for a desired period of time. The conductive yarns are also exposed to the external environment and after several wash cycles would have a different electrical resistance due to wear and tear on the conductive yarns. Moreover, exposed conductive yarns may result in oxidation on the yarns that may compromise the reliability of the heating.

Therefore, in order to address or alleviate at least the aforementioned problem or disadvantage, there is a need to provide an improved heating product.

### SUMMARY

According to a first aspect of the present disclosure, there is a heating product comprising:
a base layer;
a heating layer formed on the base layer, the heating layer comprising:
   a plurality of electrically conductive wires arranged electrically in parallel to each other; and
   thermally conductive cording yarns that attach each wire to the first fabric layer by cording embroidery, the cording yarns extending along and cording around the respective wire; and
at least one thermally conductive layer formed on the base layer,
wherein the wires are connectable to a power source for conducting an electrical current through the wires, thereby generating heat in the wires; and
wherein the at least one thermally conductive layer is arranged for substantially uniform heat transfer from the heating layer.

According to a second aspect of the present disclosure, there is a method of making a heating product, the method comprising:
forming a base layer;
forming a heating layer on the base layer, the heating layer comprising a plurality of electrically conductive wires arranged electrically in parallel to each other;
attaching each wire to the base layer by cording embroidery using thermally conductive cording yarns, the cording yarns extending along and cording around the respective wire; and
forming at least one thermally conductive layer on the base layer, wherein the wires are connectable to a power source for conducting an electrical current through the wires, thereby generating heat in the wires; and
wherein the at least one thermally conductive layer is arranged for substantially uniform heat transfer from the heating layer.

A heating product according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a cross-sectional view of a heating product according to embodiments of the present disclosure.

FIGS. 2 to 4 are illustrations of a heating layer of the heating product according to embodiments of the present disclosure.

FIGS. 5A and 5B are illustrations of both sides of the heating product according to embodiments of the present disclosure.

FIGS. 6A and 6B are illustrations of traditional embroidery and cording embroidery of the heating layer according to embodiments of the present disclosure.

FIGS. 7A and 7B are illustrations of forming the heating layer of the heating product according to embodiments of the present disclosure.

FIGS. 8A and 8B are illustrations of other configurations of the heating layer according to embodiments of the present disclosure.

FIG. 9 is an illustration of a thermally conductive layer of the heating product according to embodiments of the present disclosure.

FIG. 10 is an illustration of wearable product comprising the heating product according to embodiments of the present disclosure.

FIG. 11 is an illustration of the heating layer of the heating product integrated in the wearable product according to embodiments of the present disclosure.

FIGS. 12A and 12B are results of tests conducted on the heating product according to embodiments of the present disclosure.

### DETAILED DESCRIPTION

[symbol] disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. The recitation of a particular numerical value or value range herein is understood to include or be a recitation of an approximate numerical value or value range.

For purposes of brevity and clarity, descriptions of embodiments of the present disclosure are directed to a heating product, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

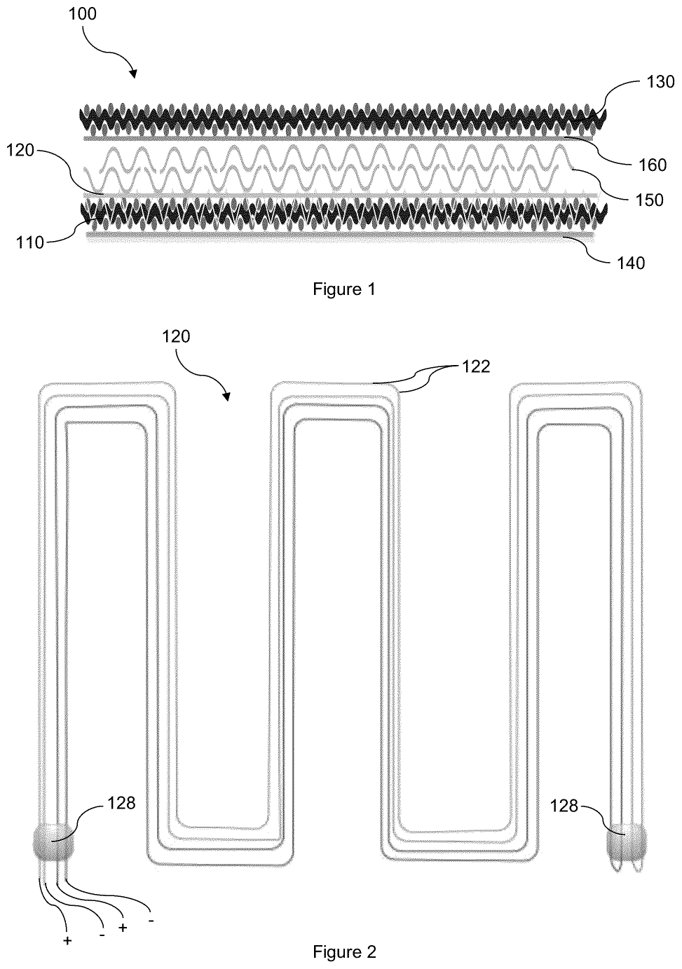

In representative or exemplary embodiments of the present disclosure, there is a heating product 100 as illustrated in FIG. 1. The heating product 100 is in the form of a composite material and comprises a base layer 110 and a heating layer 120 formed on the base layer 110. The heating product 100 may further comprise a cover layer 130 formed on the heating layer 120, wherein the heating layer 120 is interposed between the base layer 110 and cover layer 130.

The base layer 110 and cover layer 130 may be made of a fabric material which can be knitted, woven, or non-woven. Preferably, the fabric material is knitted to achieve stretchability properties. The fabric material of the base layer 110 and cover layer 130 would make the heating product 100 more suitable for integration with garments that require heating functionalities, such as to provide thermal comfort/therapeutic benefit to a user wearing the garment. Notably, when the heating product 100 is in use by the user, the base layer 110 is arranged closer to the skin of the user, and possibly with direct skin contact.

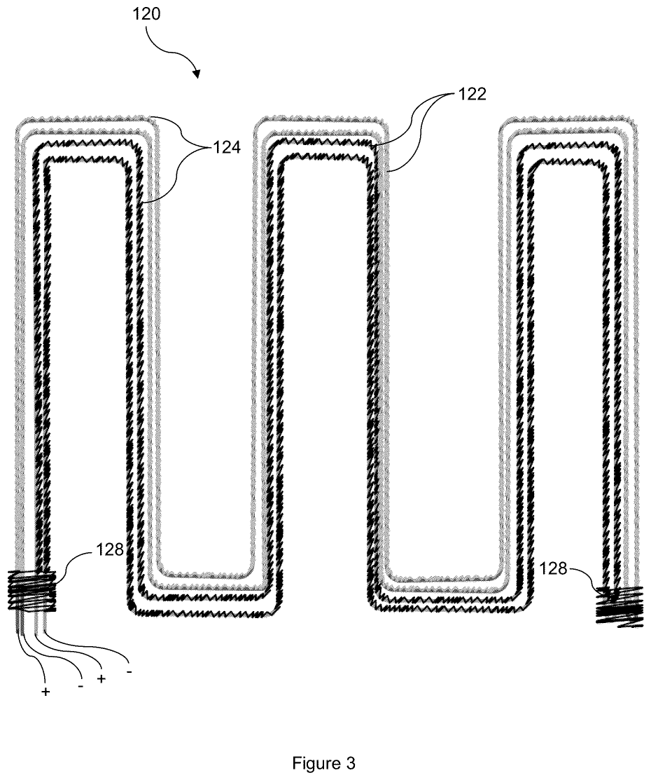

Further with reference to FIG. 2 and FIG. 3, the heating layer 120 comprises a plurality of electrically conductive wires 122 arranged electrically in parallel to each other. The wires 122 are connectable to a power source for conducting an electrical current through the wires 122, thereby generating heat in the wires 122. The electrically conductive wires 122 may be referred to as heating wires 122. More specifically, each wire 122 has an electrically positive end and an electrically negative end, and the wires 122 are arranged such that the electrical current can flow in parallel between the positive and negative ends of the respective wires 122. The heating layer 120 further comprises thermally conductive cording yarns 124 that attach each wire 122 to the base layer 110 by cording embroidery, the cording yarns 124 extending along and cording around the respective wire 122. The heating product 100 further comprises at least one thermally conductive layer 140 formed on the base layer 110, wherein the at least one thermally conductive layer 140 is arranged for substantially uniform heat transfer from the heating layer 120. The at least one thermally conductive layer 140 is described further below.

Each wire 122 may have a multifilament structure comprising a plurality of electrically conductive filaments and an insulation element surrounding the electrically conductive filaments. The electrically conductive filaments may be made of any material suitable for generating heat in response to an electrical current. For example, the electrically conductive filaments made of copper and may be coated with tin to improve sustainability. The insulation element may be made of any material suitable for electrically insulating the copper filaments from the external environment. Additionally, the insulation element may be made of a material suitable for reinforcing or strengthening the wire 122. For example, the insulation element is made of nylon or other synthetic material. The insulation element provides additional protection to the user and improves the lifespan of the heating product 100.

The multifilament structure may further comprise a protective coating around the insulation element. The protective coating which is the outermost layer of the wire 122 provides added protection and reinforcement to the wire 122 and prevents ingress of external elements, such as water penetration especially during washing of a garment integrated with the heating product 100. For example, the protective coating is made of or comprises a polymer material such as polyurethane which is tougher and more flexible so that the protective coating does not stiffen the wire 122. The overall diameter of the wire 122 is also kept small, such as up to 0.5-5 mm, to maintain flexibility of the wire 122 and to allow for better drapability of the heating product 100, especially when used in a garment. The multifilament structure may further comprise a core surrounded by the electrically conductive filaments to provide additional support to the wire 122. The core may be made of nylon or other synthetic material.

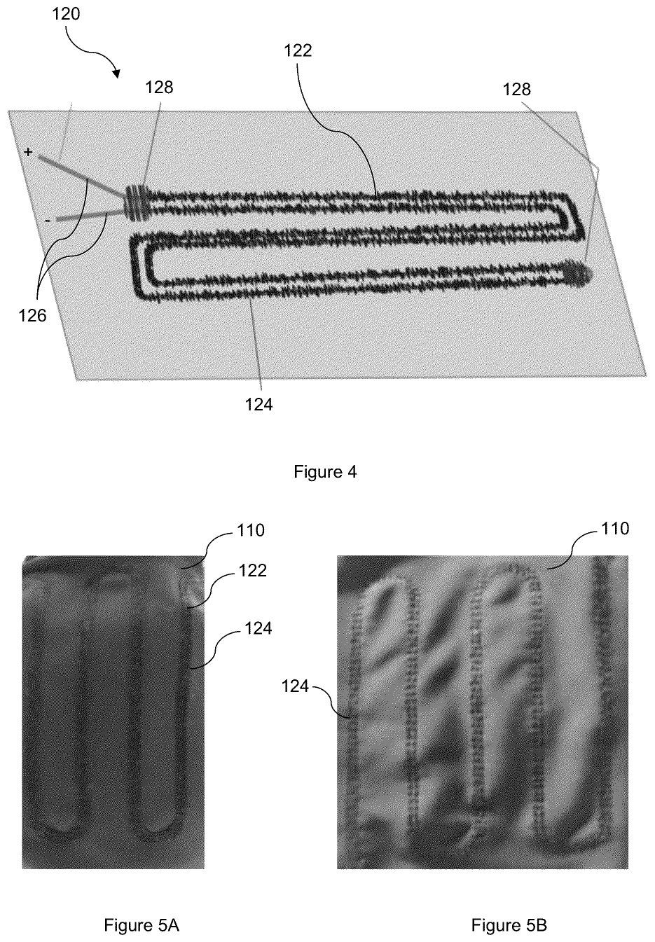

Further as shown in FIG. 4, each wire 122 is corded and attached to the base layer 110 by the thermally conductive cording yarns 124, and the ends of the wire 122 are connectable to the power source. For example, respective positive and negative ends of the wire 122 are connectable to the power source directly or via corresponding electrical elements 126, such as lead wires. The electrical elements 126 are preferably thin wires with very low electrical resistance to enable electrical current flow through the wire 122 with minimal heat generation in the electrical elements 126. The electrical elements 126 are preferably coated with a protective coating, such as waterproofing adhesive, hot glue, or polyurethane-based glue, to prevent water seepage into electrically conductive filaments of the electrical elements 126. For example, the protective coating covers any filament-exposed areas of the electrical elements 126. As the electrical elements 126 can only be exposed where they are peeled open and the exposed areas for connection to the power source are usually small, the protective coating (particularly glue) should be applied in a mild form to maintain the sleekness of the heating product 100.

In the heating layer 120, the electrically conductive or heating wires 122 are arranged electrically in parallel to each other. The heating wires 122 are electrically in parallel in terms of electrical connectivity without limiting the physical arrangement or design of the heating wires 122. Various arrangements of multiple wires 122 can be created in the heating layer 120 to cover various area sizes. For example, multiple wires 122 may be arranged in similar or dissimilar patterns and distributed across a larger area for better heating efficiency. The arrangement of the wires 122 can improve stretch and recovery properties in different directions. For example, arranging the wires 122 generally linearly along one direction can improve stretch and recovery properties along a perpendicular direction. It will be appreciated that the wires 122 can be suitably arranged to achieve such properties in one or more or all directions.

More importantly, having multiple wires 122 connected to a common power source obviates a single continuous wire for the same area and reduces overall electrical resistance as the wires 122 are electrically parallel to each other (following Ohm's law). The lower overall electrical resistance of the wires 122 would thus require the same power source to supply less electrical current at the same voltage across to generate approximately the same level of heat in the wires 122. The power source can be lighter and smaller in size to achieve the desired useable life of the heating product 100 and hence would be more portable for the user. As less electrical current is flowing through the wires 122, the heating product 100 would be safer for the user.

In one embodiment as shown in FIG. 2 and FIG. 3, the heating layer 120 has two wires 122 arranged electrically in parallel to each other. Each wire 122 may be of the same length and type, e.g. same material, such that the electrical resistance of each wire 122 is the same. For example, wires 122 of equal lengths have the same resistance and the electrical current would be distributed equally in the wires 122, resulting in low current flow in any individual wire 122. As both wires 122 are arranged electrically in parallel, the overall electrical resistance of the wires 122 will be halved. Following the Joule heating process, the heat generated in the wires 122 will increase if the same voltage is applied as the electrical current will be higher. Similarly, a lower voltage can be applied to generate the same amount of heat in the wires 122 due to the lower overall electrical resistance. It will be appreciated that the overall electrical resistance will be further reduced if more wires 122 are arranged electrically in parallel to each other.

As shown in FIG. 3 and FIG. 4, the cording yarns 124 extend along and cord around the wires 122 and attach the wires 122 to the base layer 110 by cording embroidery. The cording yarns 124 are made of any material having a high thermal conductivity value to facilitate heat transfer from the heating layer 120 to the base layer 110. For example, the cording yarns 124 are natural yarns or synthetic yarns made of polyester, nylon, or a metallic material. The wires 122 are corded embroidered across substantial lengths of the wires 122 using the cording yarns 124. The cording yarns 124 surround the wires 122 and protect the wires 122 from the external environment, such as during wash cycles. This mitigates the risk of damage on the wires 122 and maintains the electrical resistance and thermal efficiency of the wires 122 over their useable lifespan. By using the cording yarns 124 to capture the wires 122, the wires 122 are more firmly attached to the base layer 110 without compromising on the integrity of the wires 122. The heating layer 120 may further comprise reinforcement stitches 128, such as bar tack stitches, to fasten one or more portions of the wires 122 to the base layer 122. For example, the reinforcement stitches 128 are positioned at or near the end portions of the wires 122.

Further as shown in FIGS. 5A and 5B, the wires 122 are attached to the base layer 110 by cording embroidery using the cording yarns 124. The wires 122 and cording yarns 124 will be visible on one side of the base layer 110 (FIG. 5A), and only the cording yarns 124 will be visible on the other side (skin-facing side) of the base layer 110 (FIG. 5B). Cording embroidery is different from traditional embroidery as cording embroidery can be used to attach the cording yarns 124 to create 3D convex structures on one side of the fabric while forming only thin lines of threads on the other side (skin-facing side). Various design decorations may be created and formed on the base layer 110 by cording embroidery of the cording yarns 124 along the wires 122.

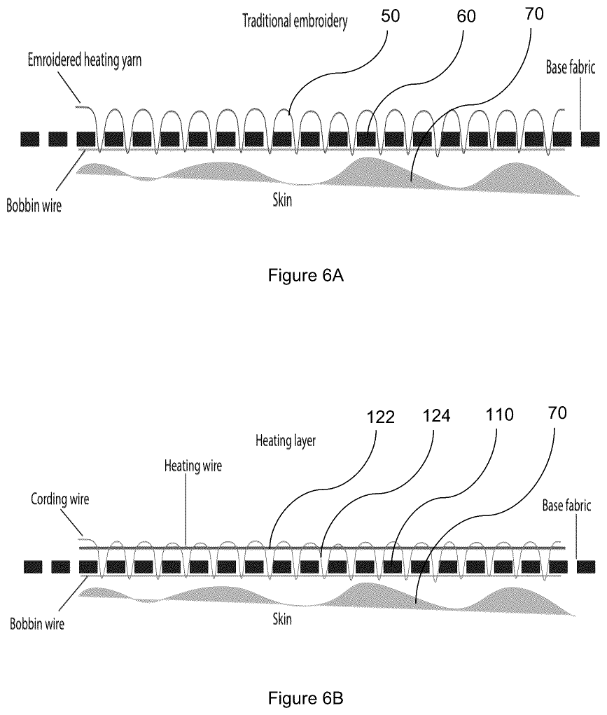

In traditional embroidery as shown in FIG. 6A, heating yarns or wires 50 are directly embroidered on and integrated with a base layer 60, such that the heating yarns 50 would be in direct contact with the skin 70. This would create localized high-temperature zones around the area of the heating yarns 50 which can lead to skin damage or necrosis, while other areas of the skin 70 that are not in contact with the heating yarns 50 would receive less heat. The non-uniform temperature distribution across the user's skin may result in changes in dermal activity. Such a heating product would likely be considered unsafe and unreliable.

In the cording embroidery of the heating product 100 as shown in FIG. 6B, the heating wires 122 are laid on the base layer 110 and the highly thermal conductive cording yarns 124 secure the heating wires 122 onto the base layer 110. The heating wires 122 are not in direct contact with the skin 70, thus avoiding localized high-temperature zones. Heat generated by the heating wires 122 efficiently delivered to the skin 70 through the combination of cording yarns 124 and thermally conductive layer 140.

In various embodiments of the present disclosure, there is a method 200 of making the heating product 100. The method comprises a step of forming the base layer 110. The method further comprises a step of forming the heating layer 120 on the base layer 110, the heating layer 120 comprising the plurality of electrically conductive wires 122 arranged electrically in parallel to each other. The method further comprises a step of attaching each wire 122 to the base layer 110 by cording embroidery using the thermally conductive cording yarns 124, the cording yarns 124 extending along and cording around the respective wire 122. A cording machine may be used to attach the wires 122 by cording embroidery using cording yarns 124. As mentioned above, the wires 122 are connectable to the power source for conducting an electrical current through the wires 122, thereby generating heat in the wires 122. The method further comprises forming at least one thermally conductive layer 140 on the base layer 110, wherein the at least one thermally conductive layer 140 is arranged for substantially uniform heat transfer from the heating layer 120. The at least one thermally conductive layer 140 is described further below.

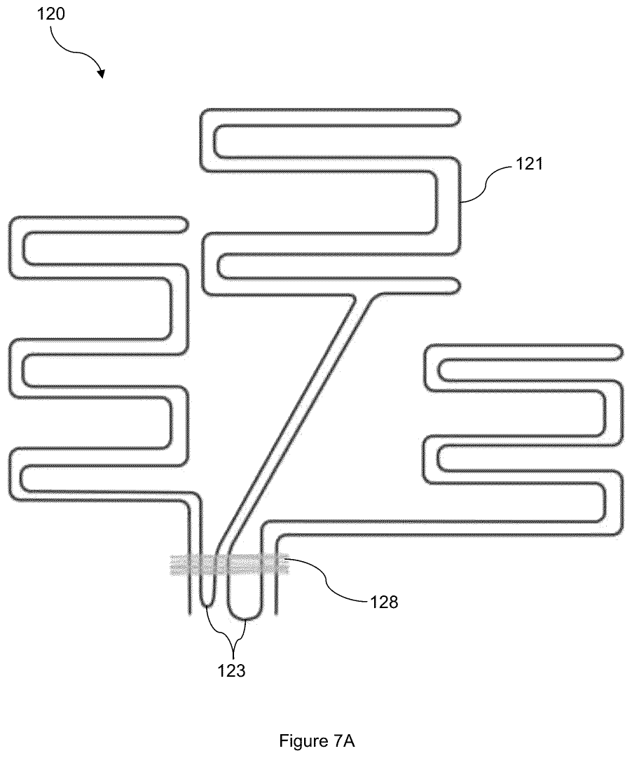

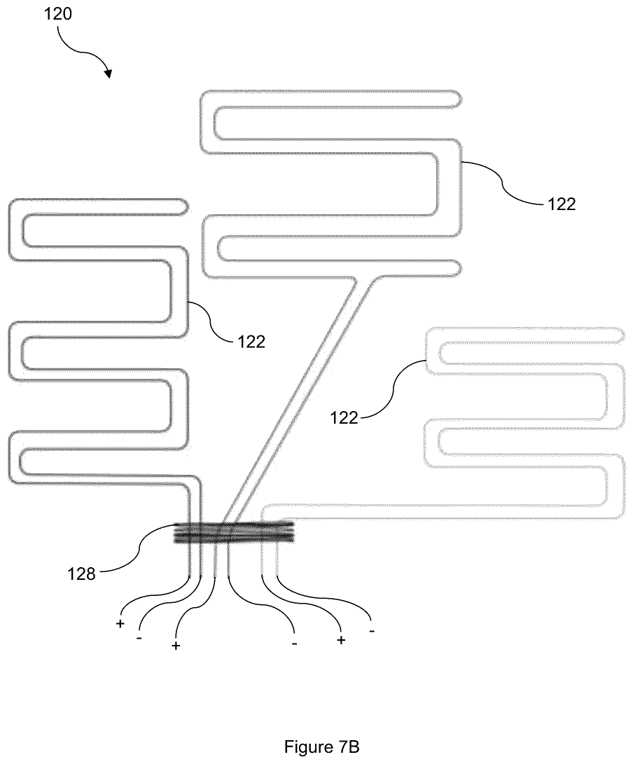

In some embodiments, the wires 122 are formed separately or piecewise on the base layer 110. In some embodiments as shown in FIG. 7A, the heating layer 120 is formed by first forming or disposing a continuous electrically conductive wire 121 on the base layer 110. More specifically, the continuous wire 121 is laid on the base layer 110 in a looping manner, forming one or more loops 123, and distributed across the desired heating area. The loops 123 are created so that they can be cut to thereby form the plurality of wires 122. The continuous wire 121 is continuously laid on the base layer 110 using the cording yarns 124 before the loops 123 are cut. There may not be any cording at the loops 123 to free portions of the wires 122 for easier cutting subsequently. Optionally, the reinforcement stitches 128 may be formed near the loops 123 as well as other areas of the continuous wire 121 to secure the continuous wire 121 onto the base layer 110.

As shown in FIG. 7B, the loops 123 are then cut to thereby form the individual wires 122, each wire 122 having its respective positive and negative ends. The positive ends of the wires 122 can be collectively connected to a common positive terminal of the power source, and similarly the negative ends of the wires 122 can be collectively connected to a common negative terminal of the power source. In this electrical circuit, the wires 122 are electrically in parallel to each other, thereby reducing their overall electrical resistance. Depending on the positions of the loops 123 that are cut, the resultant positive ends/negative ends of the wires 122 may be positioned close together or further apart. Lead wires may be used to connect the positive/negative ends together if they are separated apart to facilitate connection to the common positive/negative terminals of the power source.

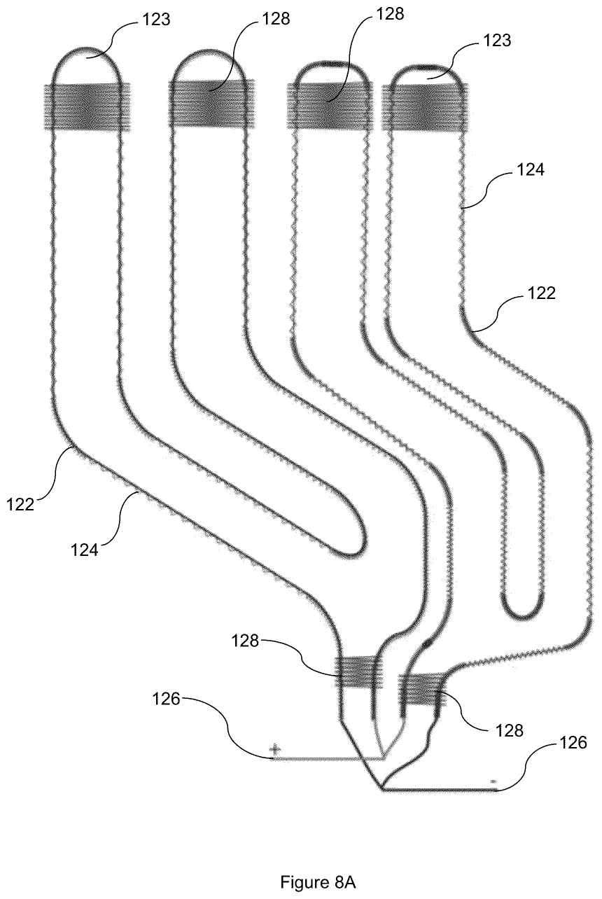

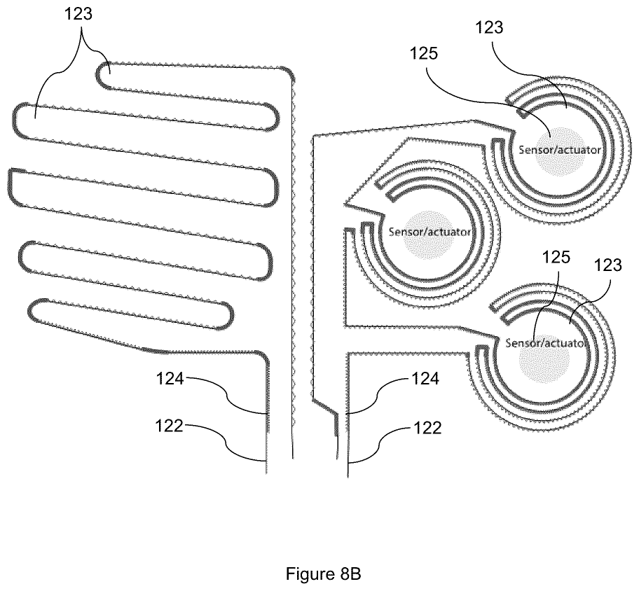

FIG. 8A shows another design and arrangement of the wires 122. A continuous wire 121 is similarly laid on the base layer 110 in a looping manner to form loops 123 and distributed across the desired heating area. Reinforcement stitches 128 may be formed near the loops 123 as well as other areas of the continuous wire 121 to secure the continuous wire 121 onto the base layer 110. The loops 123 are then cut to thereby form the individual wires 122, each wire 122 having its respective positive and negative ends. The positive and negative ends of the wires 122 can be collectively connected to respective common terminals of the power source.

FIG. 8B shows another design and arrangement of the wires 122. A continuous wire 121 is similarly laid on the base layer 110 in a looping manner to form loops 123 and distributed across the desired heating area. Additionally, the continuous wire 121 is laid around some functional elements 125 of the heating product 100 that provide certain functions to the user. For example, these functional elements 125 include sensors and actuators such as stimulation and vibration devices. This is enabled through the flexible wire arrangements and the wires 122 can be arranged to accommodate the functional elements 125 to create various combination of technologies.

Accordingly, the heating layer 120 can be formed by first disposing the continuous wire 121 and attaching it to the base layer 110 by cording embroidery using the cording yarns 124. The attached continuous wire 121 can then be cut at one or more loops 123 thereof to thereby form the plurality of wires 122 arranged electrically in parallel to each other. In this way, the wires 122 and a large number of them can be formed in a single manufacturing run or process without discontinuing the cording embroidery process. Particularly, the cording yarns 124 cord around the continuous wire 121 in a continuous run. This reduces manufacturing time as opposed to forming individual wires and attaching them individually with respective cording yarns which would be more complex and take more time. The heating product 100 can thus be manufactured more quickly and efficiently, saving production costs in the process.

In some embodiments, as the base layer 110 is arranged closer to the user's skin, the base layer 110 may comprise thermally conductive yarns to facilitate heat transfer from the heating layer 120 to the user. For example, the base layer 110 may comprise metallic yarns or may be made of a metallic material.

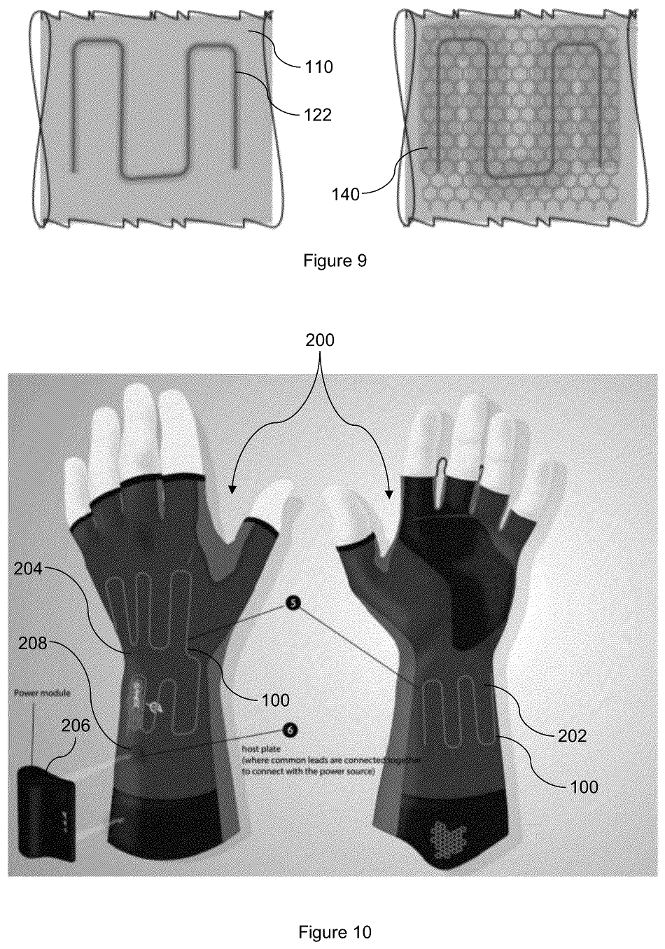

Importantly, as shown in FIG. 1 and FIG. 9, the heating product 100 further comprises at least one thermally conductive layer 140 formed on or attached to the base layer 110. The thermally conductive layer 140 may be attached to the base layer 110 such as by printing, bonding, or applying by means of adhesion. Alternatively, the thermally conductive layer 140 may be knitted or weaved into the fabric material of the base layer 110. The thermally conductive layer 140 may be made of a thin material such as graphene, gold, silver, copper, aluminium, or other metallic materials. For example, graphene has a very high thermal conductivity value of around 3000-5000 W/m·K, and a graphene coating can distribute heat from a single location efficiently across an area, thereby achieving homogeneous heating across the area. Alternatively, the thermally conductive layer 140 may be made of a material comprising a variety of fibre blends, or any material or yarns (e.g. metallic or non-metallic) with a high thermal conductivity value.

The at least one thermally conductive layer 140 is arranged for substantially uniform heat transfer from the heating layer 120. The at least one thermally conductive layer 140 may include a first thermally conductive layer 140, wherein the base layer 110 is interposed between the heating layer 120 and first thermally conductive layer 140. The first thermally conductive layer 140 is arranged to be close to the skin, possibly with direct skin contact, and facilitates substantially uniform heat transfer from the heating layer 120 to the user. The first thermally conductive layer 140 laterally dissipates heat generated by the heating layer 120 more efficiently across a wider area, thereby uniformly spreading the heat across the user's skin. As such, the wires 122 do not need to cover the whole desired heating area and the heat generated in the wires 122 can be spread to areas not covered by the wires 122. This shortens the overall length of the wires 122 used, reduces wire density across the heating product 100, saves material usage and costs, and improves material flexibility.

The thermally conductive layer 140 helps with thermal stabilisation of the heat generated by the heating layer 120, provides homogenous thermal comfort to the user, and maintains consistent temperature across the heating product 100. For example, the heating product 100 is integrated in a therapeutic product such as a garment and having consistent heating across the desired heating area improves therapeutic benefit to the user. In some embodiments, the at least one thermally conductive layer 140 may comprise a second thermally conductive layer 140 formed on the reverse side of the base layer 110 and interposing the base layer 110 and heating layer 120. In some embodiments, the heating product 100 may comprise both the first and second thermally conductive layers 140 cooperative to facilitate substantially uniform heat distribution to the user, minimizing the temperature gradient across the user's skin that is in contact with the heating product 100.

In some embodiments as shown in FIG. 1, the heating product 100 further comprises a thermal insulation layer 150 formed on or attached to the heating layer 120, wherein the heating layer 120 is interposed between the base layer 110 and thermal insulation layer 150. The thermal insulation layer 150 functions as a barrier to reduce heat loss that is generated by the heating layer 120 and directed away from the user's skin, thereby improving thermal efficiency of the heating product 100 and heat retention on the user's skin. The thermal insulation layer 150 is preferably thin, lightweight, and flexible and has a thickness of not more than 2-3 mm. The thermal insulation layer 150 may be made of any knitted, woven, or non-woven material having a low thermal conductivity value. The thermal insulation layer 150 is preferably porous or has an open-space structure. For example, the thermal insulation layer 150 is made of a 3D fabric or spacer or foam. Alternatively, the thermal insulation layer 150 is made of an aerogel material which is a synthetic, porous, and lightweight material that has very low density and thermal conductivity. The porous or open-space structure of the thermal insulation layer 150 creates air spaces in the thermal insulation layer 150 to capture air, which has a very low thermal conductivity value of around 0.02 W/m·K, thereby reducing overall heat loss to the external environment in a cost-effective manner.

In some embodiments as shown in FIG. 1, the heating product 100 further comprises a thermal reflective layer 160 formed on or attached to the thermal insulation layer 150, wherein the thermal insulation layer 150 is interposed between the heating layer 120 and thermal reflective layer 160. The thermal reflective layer 160 may be formed on the underside of the cover layer 130 as a coating or laminate or a bonded layer. The thermal reflective layer 160 may have pores for air permeation through the heating product 100. The thermal insulation layer 150, particularly with its porous structure, forms a buffer or gap between the heating layer 120 and thermal reflective layer 160. Any heat loss through the thermal insulation layer 150 would be reflected by the thermal reflective layer 160 and radiated back towards the heating layer 120. This further reduces overall heat loss and improves thermal efficiency. The thermal reflective layer 160 is made of a material with a low emissivity value that is preferably close to zero to reflect at least 95% of the heat that is radiated to the thermal reflective layer 160. The material may be aluminium, gold, or silver. For example, aluminium has a low emissivity value of 0.03 which reflects 97% of the heat back to the heating layer 120.

The thermal insulation layer 150 and thermal reflective layer 160 are thus cooperative to preserve most of the heat that is generated by the heating layer 120 and to redirect most of the heat towards the user. This combination reduces overall heat loss to the external environment and improves the overall thermal efficiency of the heating product 100. Less power would be required to heat the wires 122 and generate the desired temperature and thermal comfort for the user.

In some embodiments, the wires 122 are attached directly onto the base layer 110 by cording embroidery using the cording yarns 124. In some embodiments, the heating layer 120 further comprises an intermediary layer or film and the wires 122 are attached onto the intermediary layer. The intermediary layer is made of a material that allows the heating layer 120 to be transferred and attached to the base layer 110 such that the intermediary layer interposes the heating layer 120 and base layer 110. For example, the intermediary layer is made of thermoplastic polyurethane which is a film-like that can be bonded or glued to other surfaces.

The heating product 100 can be integrated in various products, such as wearable products or garments, that may incorporate various other technologies, such as to provide therapeutic benefits to users. There are applications of the heating product 100 where such heating can be used for therapeutic treatment purposes by providing stable homogenous temperature for longer period of time to an area. The thin and flexible structure of the heating product 100 enables it to be easily integrated in other products. One reason for this versatility is the arrangement of the wires 122 allows space for integrating components for other technologies in the same heating product 100. For example, the technologies may relate to pulsed electromagnetic field (PEMF) therapy, transcranial magnetic stimulation (TMS)/repetitive TMS (rTMS), transcranial direct current stimulation (tDCS), photobiomodulation (PBM), electromyography (EMG), electrical muscle stimulation (EMS), cold therapy, active compression, vibration therapy, and with ointment dispersion in combination with heating, etc. Various types of sensors/actuators, such as thermal sensors, may be added to the heating product 100 to measure various types of data that can complement the technologies.

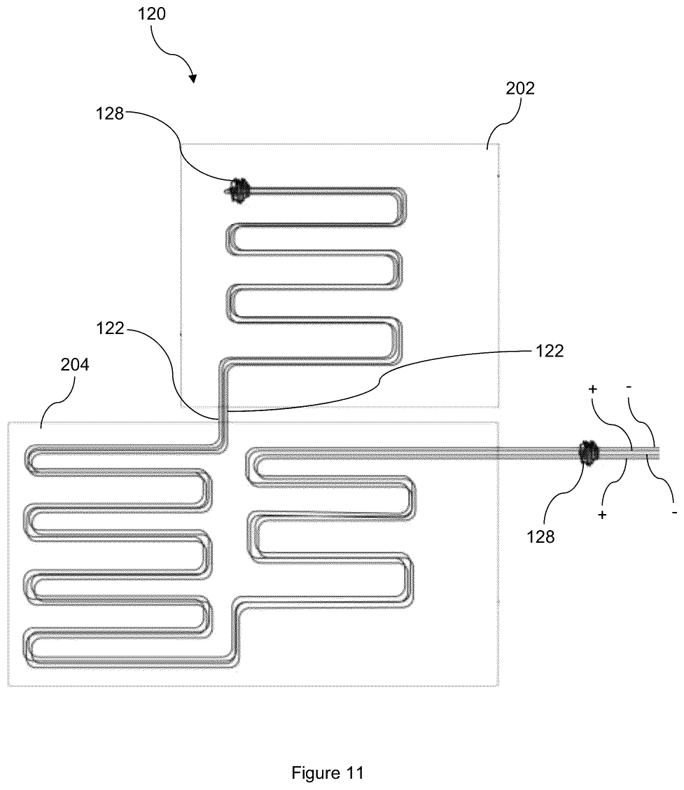

In some embodiments, there is a wearable product, such as a garment, comprising a fabric body and the heating product 100 attached to the fabric body. In one embodiment as shown in FIG. 10, the wearable product is a heating glove 200 comprising the heating product 100. The heating glove 200 can be used for gaming to provide hand/wrist thermal comfort to active gamers. The heating product 100 is embedded in the fabric body of the heating glove 200 such that the heating layer 120 is distributed over two areas of the heating glove 200, namely the wrist area 202 and the dorsal area 204. Particularly, the wrist area 202 is arranged to cover the volar side of the user's wrist, and the dorsal area 204 is arranged to cover the dorsal side of the user's hand and/or wrist. FIG. 11 illustrates the electrical circuit of the electrically-parallel wires 122 in the heating layer 120. Notably, the wires 122 loop around the wrist area 202 and dorsal area 204 and terminate at around the same area for connection to the power source 206 such as a battery or power bank.

The heating glove 200 may comprise an intermediary connector 208, such as a host plate, to connect between the wires 122 (or electrical elements/lead wires 126 if connected to the ends of the wires 122) and the power source 206. The intermediary connector 208 comprises suitable connection elements for the power source 206 to connect to. The connection elements are configured to allow ease of attachment and detachment of the power source 206 so that the user can use the heating glove 200 as and when necessary. The connection elements may comprise a pair of magnetic elements that correspond to the positive and negative terminals of the power source 206. The magnetic elements may be made of neodymium and are lightweight with high connection strength. For example, the pair of magnetic elements can have a connection strength of close to 21 N or over 2 kg. This connection strength allows the power source 206 to have a weight of close to 100 g while keeping it securely fastened to the heating glove 200 even with hand motions by the user. In another example, the connection elements may comprise USB connectors or ports. It will be appreciated that the connection elements can be of various types to facilitate ease of physical and electrical connection between the power source 206 and the heating glove 200.

The heating glove 200 can be used to achieve active thermal comfort/therapeutic benefit. The heating glove 200 is able to generate heat in the heating wires 122 to a temperature of around 50° C. and achieve the desired temperature on the user's skin without causing any discomfort to the user. In the electrical circuit of the heating glove 200, the overall electrical resistance is below 2.5Ω and the power source 206 is a 3.7 V battery. Due to the low resistance, the heating glove 200 can be powered by the battery for close to 1.5 hours at the desired temperature. A lower resistance would generally be beneficial for small systems and garments that have limited space for the wires 122.

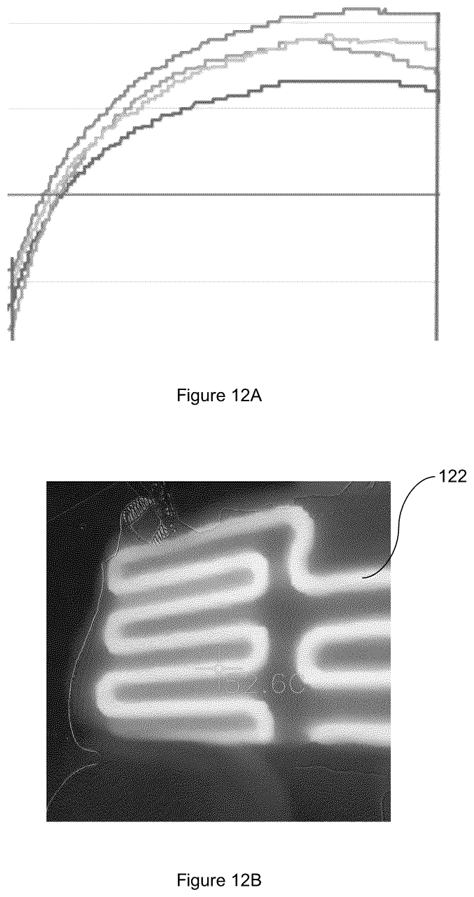

The heating glove 200 was found to be effective at providing thermal comfort to users with repetitive strain injury. The thin and flexible structure of the heating product 100 also enables the heating glove 200 to achieve a sleek profile. Additionally, the wearable product or heating glove 200 may be integrated with active/passive compression properties that complement the heating properties from the heating product 100. For example, the wearable product or heating glove 200 comprises compression elements attached to the fabric body, the compression elements configured for applying compression pressure. Such heating glove 200 was tested with several groups of users and these users reported better thermal comfort and reduced pain in their fingers, hand, and around the wrist areas together with improved player performance and play time after weeks of use. Tests were also conducted on the heating glove 200 to investigate the time taken for the heating glove 200 to reach a peak temperature. According to the test results shown in FIGS. 12A and 12B, the heating glove 200 was able to reach the desired peak temperature in less than 120 seconds. Once the peak temperature was reached, this was held stable throughout the entirety of the treatment cycle. A low-voltage battery with low MWh capacity was able to power the heating product 100 used in the gaming glove 200 for over 90 minutes. Use of a small battery module has benefits of safety as well as being lightweight and the possibility of designing sleek and attractive end products.

The heating product 100 functions as a lightweight, drapeable, and flexible product that is very thin in nature and can be incorporated with other products such as garments with any form factor. The heating product 100 has an overall thickness below 2 mm and this enables the heating product 100 to be easily integrated into any type of garments from gloves to socks to jackets. The heating product 100 uses a combination of the heating layer 120 (having the heating wires 122 and corded yarns 124) and thermal dissipation layer to dissipate heat uniformly and efficiently across a wider area. For example, the heating product 100 is integrated in a garment and the user wearing the garment would feel the heat uniformly distributed on the user's skin.

Ideally, the temperature gradient across the heating area on the user's skin has a maximum of 3-5° C. Thermal comfort on the human skin ranges between 33.5-36.9° C., depending on the position or area of the body and internal thermoregulation of the body. Numerous studies have shown that cell death rate increases exponentials as the temperature level on exposed skin increases, and this effect is further accelerated with exposure time. The superficial layer of the skin should not be exposed to temperatures above 50° C. for a long period of time, which would lead to skin damage or necrosis. The heating product 100 is able to achieve a peak temperature of around 50° C. in the heating wires 122, and the temperature felt by the user would thus be below the safety threshold of 50° C. The uniform heat distribution ensures that the heating product 100 meets the safety criteria required for a good thermal stimulation product by utilizing lower current and avoiding direct skin contact of heating elements while still delivering desired heating required and within the levels established as safe for human skin.

In the foregoing detailed description, embodiments of the present disclosure in relation to a heating product are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A heating product comprising:
a base layer;
a heating layer formed on the base layer, the heating layer comprising:
a plurality of electrically conductive wires arranged electrically in parallel to each other; and
thermally conductive cording yarns that attach each wire to the first fabric layer by cording embroidery, the cording yarns extending along and cording around the respective wire; and
at least one thermally conductive layer formed on the base layer,
wherein the wires are connectable to a power source for conducting an electrical current through the wires, thereby generating heat in the wires; and
wherein the at least one thermally conductive layer is arranged for substantially uniform heat transfer from the heating layer.

2. The heating product according to claim 1, wherein the base layer comprises thermally conductive yarns.

3. The heating product according to claim 1, wherein the at least one thermally conductive layer comprises a first thermally conductive layer, wherein the base layer is interposed between the heating layer and first thermally conductive layer.

4. The heating product according to claim 1, wherein the at least one thermally conductive layer comprises a second thermally conductive layer interposed between the heating layer and base layer.

5. The heating product according to claim 1, further comprising a thermal insulation layer formed on the heating layer, wherein the heating layer is interposed between the base layer and thermal insulation layer.

6. The heating product according to claim 5, wherein the thermal insulation layer is porous.

7. The heating product according to claim 5, further comprising a thermal reflective layer formed on the thermal insulation layer, wherein the thermal insulation layer is interposed between the heating layer and thermal reflective layer.

8. The heating product according to claim 1,
further comprising a cover layer formed on the heating layer, wherein the heating layer is interposed between the base layer and cover layer.

9. The heating product according to claim 1, wherein each wire has a multifilament structure comprising:
a plurality of electrically conductive filaments; and
an insulation element surrounding the electrically conductive filaments.

10. The heating product according to claim 9, wherein the multifilament structure further comprises a protective coating around the insulation element.

11. (canceled)

12. A method of making a heating product, the method comprising:
forming a base layer;
forming a heating layer on the base layer, the heating layer comprising a plurality of electrically conductive wires arranged electrically in parallel to each other;
attaching each wire to the base layer by cording embroidery using thermally conductive cording yarns, the cording yarns extending along and cording around the respective wire; and
forming at least one thermally conductive layer on the base layer,
wherein the wires are connectable to a power source for conducting an electrical current through the wires, thereby generating heat in the wires; and
wherein the at least one thermally conductive layer is arranged for substantially uniform heat transfer from the heating layer.

13. The method according to claim 12, wherein forming the heating layer comprises:
forming a continuous electrically conductive wire on the base layer; and
cutting the continuous wire at one or more loops thereof to thereby form the plurality of electrically conductive wires.

14. The method according to claim 12, wherein attaching of each wire comprises attaching the continuous wire to the base layer by cording embroidery before cutting the loops.

15. (canceled)

16. (canceled)

17. (canceled)

18. (canceled)

19. (canceled)

20. A wearable product comprising:
a fabric body; and
a heating product according to claim 1, the heating product attached to the fabric body.

21. The wearable product according to claim 20, further comprising an intermediary connector to connect between the wires and the power source.

22. The wearable product according to claim 21, wherein the intermediary connector comprises a pair of magnetic elements that correspond to positive and negative terminals of the power source.

23. The wearable product according to claim 20,
wherein the wearable product is therapeutic product.

24. The wearable product according to claim 20, further comprising compression elements attached to the fabric body, the compression elements configured for applying compression pressure.

25. (canceled)

26. The heating product according to claim 1, wherein the at least one thermally conductive layer is made of graphene.

27. The heating product according to claim 7, wherein the thermal reflective layer is made of aluminum.
